(19) United States
(12) Patent Application Publication
(10) Pub. No.: US 2020/0391698 A1
(43) Pub. Date: Dec. 17, 2020

(54) ELECTROMAGNETIC WAVE UTILIZATION SYSTEM

(71) Applicant: DENSO CORPORATION, Kariya-city (JP)

(72) Inventors: Kotaro FUKUDA, Kariya-city (JP); Koji OTA, Kariya-city (JP); Junji GOTO, Kariya-city (JP); Tatsuhiko NISHINO, Kariya-city (JP); Naoki YOKOYAMA, Kariya-city (JP)

(21) Appl. No.: 17/004,927

(22) Filed: Aug. 27, 2020

Related U.S. Application Data
(63) Continuation of application No. PCT/JP2019/000178, filed on Jan. 8, 2019.

(30) Foreign Application Priority Data
Mar. 7, 2018 (JP) 2018-040704

(51) Int. Cl. B60S 1/02; B60J 1/02; B60R 11/04; G01S 17/93; G01S 7/481; H05B 3/84

(52) U.S. Cl. CPC B60S 1/02; B60J 1/02; H05B 3/84; G01S 17/93; G01S 7/481; B60R 11/04

(57) ABSTRACT

An electromagnetic wave utilization system includes an electromagnetic wave device configured to send or/and receive an electromagnetic wave, and a passage part through which passes the electromagnetic wave utilized by the electromagnetic wave device. The passage part includes an inner member provided to face the electromagnetic wave device, an outer member provided on the opposite side to the electromagnetic wave device, and a heat insulating portion disposed between the inner member and the outer member so as to suppress fogging on a portion of the inner member through which the electromagnetic wave passes.

### CROSS REFERENCE TO RELATED APPLICATION

The present application is a continuation application of International Patent Application No. PCT/JP2019/000178 filed on Jan. 8, 2019, which designated the U.S. and claims the benefit of priority from Japanese Patent Application No. 2018-40704 filed on Mar. 7, 2018. The entire disclosures of all of the above applications are incorporated herein by reference.

### TECHNICAL FIELD

The present disclosure relates to an electromagnetic wave utilization system that uses electromagnetic waves.

### BACKGROUND

An in-vehicle camera captures an image of a rear view of a vehicle. The in-vehicle camera is installed on the ceiling in the vehicle cabin in proximity to the rear window, and captures an image of the outside through the rear window.

### SUMMARY

In one aspect of the present disclosure, the electromagnetic wave utilization system includes:

an electromagnetic wave device configured to send or/and receive an electromagnetic wave; and

a passage part through which passes the electromagnetic wave utilized by the electromagnetic wave device.

The passage part includes: an inner member provided to face the electromagnetic wave device; an outer member provided opposite to the electromagnetic wave device; and a heat insulating portion disposed between the inner member and the outer member so as to suppress fogging on a portion of the inner member, where the electromagnetic wave passes, to exert a heat insulating function.

### BRIEF DESCRIPTION OF DRAWINGS

FIG. 1 is a cross-sectional view of a vehicle equipped with an imaging device according to a first embodiment.

FIG. 2 is a partially enlarged cross-sectional view illustrating the imaging device of FIG. 1.

FIG. 3 is a plan view of a heater.

FIG. 4 is a flowchart illustrating a control process executed by a control device of the imaging device according to the first embodiment.

FIG. 5 is a cross-sectional view illustrating a laser device according to a second embodiment.

FIG. 6 is a view as viewed in an arrow direction VI in FIG. 5.

### DESCRIPTION OF EMBODIMENT

To begin with, examples of relevant techniques will be described.

An in-vehicle camera captures an image of a rear view of a vehicle. The in-vehicle camera is installed on the ceiling in the vehicle cabin in proximity to the rear window, and captures an image of the outside through the rear window.

In this art, the in-vehicle camera is installed so that a heater wire of the defogger on the rear window is not included in the imaging range of the camera. The defogger is a device that clears fog on the rear window by heating the rear window with the heater wire.

According to this art, since the in-vehicle camera is installed so that the heater wire of the defogger in the rear window does not enter the imaging range, the view area of the in-vehicle camera is not obstructed by the heater wire of the defogger.

However, according to this art, since there is no heater wire of the defogger in the imaging range, the fogging in the imaging range cannot be effectively cleared. Therefore, under the condition that fogging is generated on the rear window, there is a possibility that the visibility and the view area of the in-vehicle camera may not be sufficiently secured.

This issue occurs not only in the in-vehicle camera that captures visible light, but also in various vehicle electromagnetic wave utilization systems that use electromagnetic waves, such as a laser device that transmits and receives laser light for a vehicle.

The present disclosure provides an electromagnetic wave utilization system that can heat a passage part through which an electromagnetic wave passes without restricting passage of the electromagnetic wave.

In one aspect of the present disclosure, the electromagnetic wave utilization system includes:

an electromagnetic wave device configured to send or/and receive an electromagnetic wave; and

a passage part through which passes the electromagnetic wave utilized by the electromagnetic wave device.

The passage part includes: an inner member provided to face the electromagnetic wave device; an outer member provided opposite to the electromagnetic wave device; and a heat insulating portion disposed between the inner member and the outer member so as to suppress fogging on a portion of the inner member, where the electromagnetic wave passes, to exert a heat insulating function.

Accordingly, it is possible to restrict fogging with a simple configuration without consuming power such as electric power.

Hereinafter, embodiments will be described with reference to the drawings. In the following embodiments, identical or equivalent elements are denoted by the same reference numerals as each other in the drawings.

### First Embodiment

Hereinafter, an imaging device for a vehicle according to the present embodiment will be described with reference to the drawings. In the drawings, the up, down, front and rear arrows indicate the up, down, front and rear directions of the vehicle. The imaging device corresponds to a vehicular electromagnetic wave utilization system that uses visible light, which is a type of electromagnetic waves.

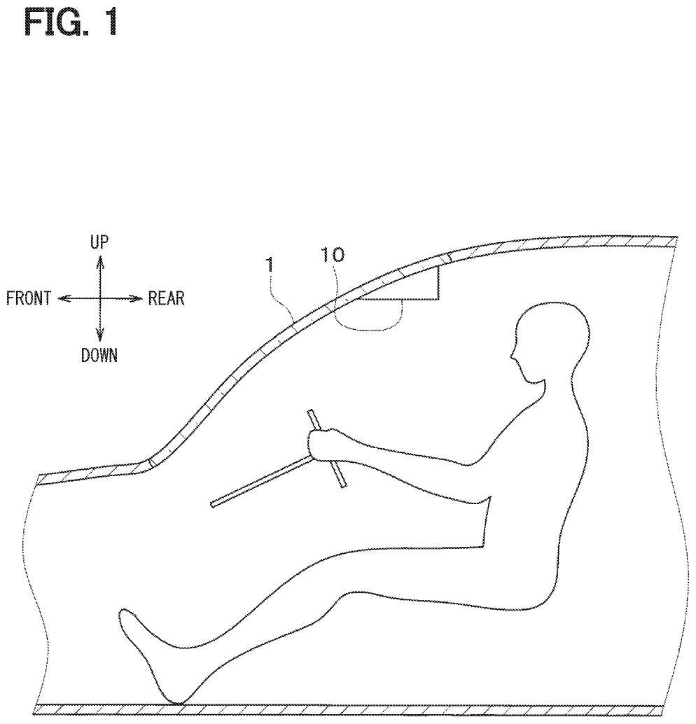

As shown in FIG. 1, a camera unit 10 is mounted on an inner surface of the windshield 1 of the vehicle in the cabin. The camera unit 10 is attached to the upper portion of the windshield 1 and is located at a substantially central portion in the left-right direction. The camera unit 10 is located near a rear-view mirror (not shown).

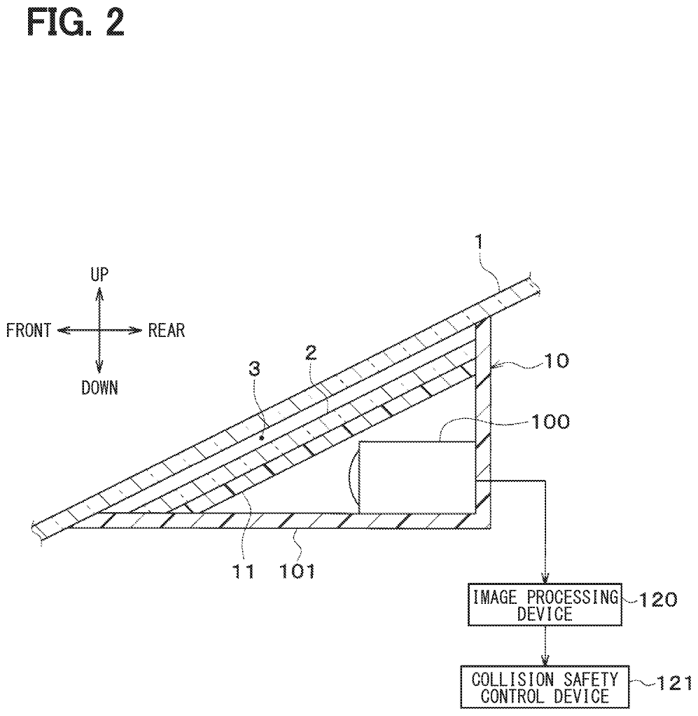

As shown in FIG. 2, the camera unit 10 has a camera 100 and a housing 101. The camera 100 captures an image of the outside in front of the vehicle through a window (the windshield 1 in this embodiment) of the vehicle. The camera 100 is an electromagnetic wave device that captures visible light, which is a type of electromagnetic waves. The windshield 1 is a passage part through which the visible light captured by the camera 100 passes.

An inner glass 2 is disposed between the windshield 1 and the camera 100 inside the housing 101. The inner glass 2 forms a double structure with the windshield 1. That is, the windshield 1 and the inner glass 2 form a double window.

The inner glass 2 is an inner member of the double window provided on the inner side in the vehicle cabin. The windshield 1 is an outer member of the double window provided on the outer side in the vehicle cabin.

A heat insulating portion 3 is formed between the inner glass 2 and the windshield 1. The heat insulating portion 3 exhibits a heat insulating function so as to suppress fogging on a portion of the inner glass 2 through which visible light captured by the camera 100 passes. The heat insulating portion 3 exhibits a heat insulating function by being in a vacuum.

The image data captured by the camera 100 is input to the image processing device 120. The image processing device 120 processes the image data of the camera 100 and detects an object in front of the vehicle. The detection result of the image processing device 120 is output to the collision safety control device 121. The collision safety control device 121 controls a brake or the like of the vehicle based on the detection result of the image processing device 120 to restrict a collision of the vehicle.

The camera 100 is housed in the housing 101. The housing 101 is a member that forms an outer shell of the camera unit 10. The housing 101 may be in close contact with the windshield 1 or a predetermined gap may be provided between the housing 101 and the windshield 1.

A heater 11 is disposed on the inner glass 2. The heater 11 heats the inner glass 2 by generating heat to clear the fogging on the surface of the inner glass 2 on the interior side in the cabin.

The heater 11 is a transparent thin film member. The heater 11 can be attached to a surface of the windshield 1 on the interior side in the cabin. The heater 11 may be embedded inside the windshield 1.

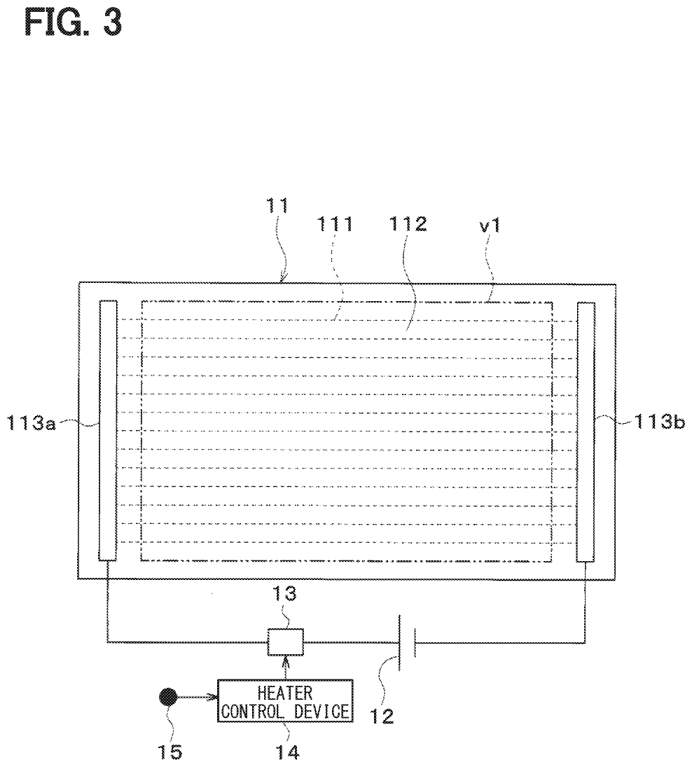

As shown in FIG. 3, the heater 11 has a carbon nanotube 111 and a binder 112. The carbon nanotube 111 is a heating element that generates heat when a current flows. In FIG. 3, for convenience of illustration, the carbon nanotubes 111 are indicated by broken straight lines.

The carbon nanotube 111 (also called CNT) is a carbon crystal having a hollow cylindrical structure. The diameter of the carbon nanotube 111 is 0.7 to 70 nm, which is about tens of thousands of a hair. The carbon nanotube 111 is a tube-shaped substance having a length of several tens pm or less.

The binder 112 is a holding unit that holds the carbon nanotube 111. The binder 112 is made of a transparent resin.

For example, the heater 11 is a thin film in which the carbon nanotubes 111 are dispersed in the binder 112. The heater 11 may have plural linear heating wires formed using the carbon nanotubes 111. The diameter of the wire formed by using the carbon nanotube 111 is about several pm.

The carbon nanotube 111 is so thin that the carbon nanotube 111 cannot be identified with the naked eye. The wire formed using the carbon nanotubes 111 is also a thin member that cannot be identified with the naked eye. Therefore, the heater 11 looks transparent to the naked eye. The carbon nanotubes 111 can absorb light and restrict light scattering.

The heater 11 has electrodes 113a and 113b. The electrodes 113a and 113b are connected to the carbon nanotube 111.

When a DC voltage is applied to the electrodes 113a and 113b from the battery 12 of the vehicle, a current flows through the carbon nanotubes 111 to generate heat. The electrodes 113a and 113b are formed in an elongated shape along the sides of the heater 11.

The power supply unit 13 applies a DC voltage from the battery 12 to the electrodes 113a and 113b. The power supply unit 13 has a relay or a switch. The operation of the power supply unit 13 is controlled by the heater control device 14.

The heater 11 is disposed so as to overlap the entire range of the view area v1 of the camera 100. In FIG. 3, the view area v1 of the camera 100 is indicated by a two-dot chain line for easy understanding. The heater 11 is arranged in a range slightly wider than the view area v1 of the camera 100.

The electrodes 113a and 113b of the heater 11 are arranged outside the view area v1 of the camera 100. This restricts the view area v1 of the camera 100 from being obstructed by the heater 11.

The heater control device 14 includes a well-known microcomputer including a CPU, a ROM, a RAM, and the like, and peripheral circuits thereof. The heater control device 14 performs various calculations and processes based on a control program stored in the ROM, and controls the operation of various devices connected to the output side.

A window surface humidity sensor 15 is connected to an input side of the heater control device 14. The window surface humidity sensor 15 includes a window vicinity humidity sensor, a window vicinity air temperature sensor, and a window surface temperature sensor.

The window vicinity humidity sensor detects the relative humidity of air near the windshield 1 in the vehicle cabin (hereinafter, referred to as window vicinity relative humidity). The window vicinity air temperature sensor detects the temperature of air near the windshield 1 in the vehicle cabin. The window surface temperature sensor detects the surface temperature of the windshield 1.

The power supply unit 13, the heater control device 14, and the window surface humidity sensor 15 correspond to a heater control unit that controls the operation of the heater 11.

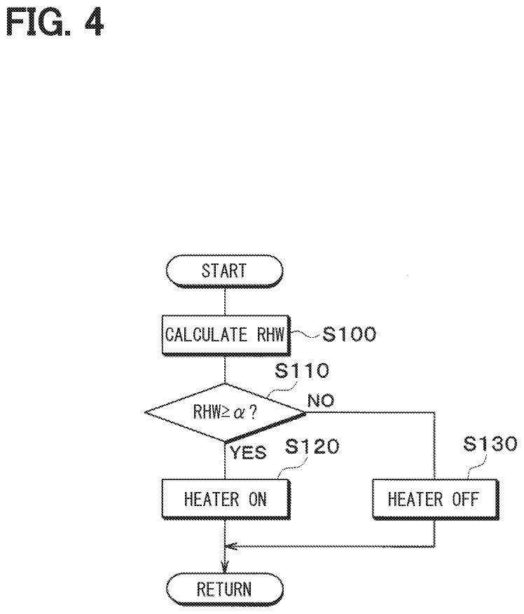

The heater control device 14 executes a control process shown in the flowchart of FIG. 4. The flowchart of FIG. 4 shows a subroutine of a control program executed by the heater control device 14.

First, in step S100, the relative humidity RHW of the inner surface of the windshield 1 in the cabin (hereinafter, referred to as window surface relative humidity) is calculated based on the detection value of the window surface humidity sensor 15.

The window surface relative humidity RHW is an index indicating a possibility that the windshield 1 is fogged. Specifically, the larger the value of the window surface relative humidity RHW, the higher the possibility that the windshield 1 will be fogged.

In step S110, it is determined whether the window surface relative humidity RHW is greater than or equal to a threshold value a. If it is determined in step S110 that the window surface relative humidity RHW is greater than or equal to the threshold a, the process proceeds to step S120, and the heater 11 is caused to generate heat. Specifically, the heater control device 14 applies a DC voltage from the battery 12 of the vehicle to the electrodes 113a and 113b of the heater 11.

Thereby, when the possibility of fogging of the windshield 1 is high, the windshield 1 is heated by the heater 11 to restrict the fogging of the windshield. When the windshield 1 is fogged, the windshield 1 is heated by the heater 11 to clear the fogging of the windshield 1.

If it is determined in step S110 that the window surface relative humidity RHW is not greater than or equal to the threshold a, the process proceeds to step S130, and the heat generation of the heater 11 is stopped. Specifically, the heater control device 14 stops the application of the DC voltage to the electrodes 113a and 113b of the heater 11.

In the present embodiment, the heat insulating portion 3 has a heat insulating function between the inner glass 2 and the windshield 1 so as to suppress fogging on a portion of the inner glass 2 through which the electromagnetic wave passes. According to this, it is possible to restrict fogging with a simple configuration without consuming power such as electric power.

In the present embodiment, the heat insulating portion 3 exhibits a heat insulating function by being in a vacuum. Thereby, high heat insulation can be exhibited.

In the present embodiment, the heater 11 is provided for heating the inner glass 2. Thereby, the heat of the heater 11 can be suppressed from being radiated to the outside air, and the efficiency of the antifogging by the heater 11 can be increased.

### Second Embodiment

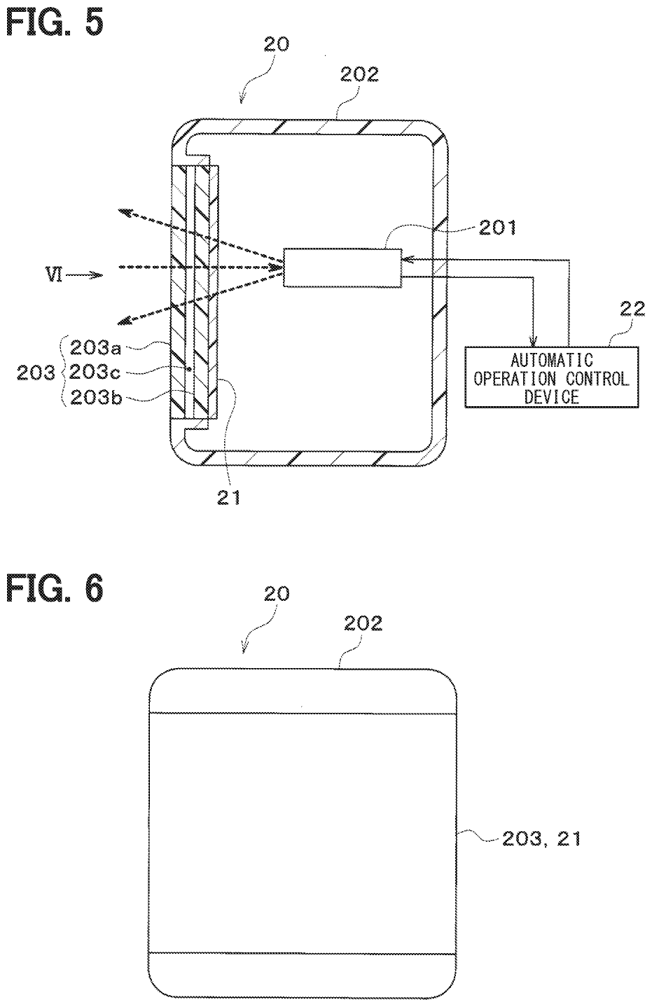

In the above-described embodiment, an imaging device for a vehicle includes the heater 11. In the present embodiment, a laser device 20 for a vehicle includes the heater 21 as described with reference to FIGS. 5 and 6.

The laser device 20 irradiates a pulse of laser light, which is a type of electromagnetic wave, and measures the distance, direction, attributes, and the like of the target object based on the time period taken until the light is reflected by the object and returns back. The laser device 20 is used, for example, as a sensor for automatic driving of the vehicle.

The laser device 20 includes a laser transmitter 201, a housing 202, and a cover 203. The laser transmitter 201 is a device that irradiates a laser beam and detects an object and measures a distance to the object by receiving the laser beam reflected back from the object.

For example, the laser device 20 is mounted on a bumper (not shown) of the vehicle. The laser device 20 irradiates the laser light toward the front of the vehicle, and receives the laser light returned from the front of the vehicle. The laser light emitted by the laser device 20 is, for example, a laser light having a near-infrared wavelength.

The operation of the laser transmitter 201 is controlled by the automatic operation control device 22. The result of detection and the result of measurement by the laser transmitter 201 are input to the automatic operation control device 22. The automatic operation control device 22 performs automatic operation of the vehicle based on the detection result and the measurement result by the laser transmitter 201.

The laser transmitter 201 is housed in a space closed by the housing 202 and the cover 203. The housing 202 and the cover 203 are members that house the laser transmitter 201 and protect the laser transmitter 201. The housing 202 is arranged in an area through which laser light transmitted and received by the laser transmitter 201 does not pass. The cover 203 is arranged in a region through which the laser light transmitted and received by the laser transmitter 201 passes. The cover 203 is made of resin.

The cover 203 has a double structure. Specifically, the cover 203 has an outer cover 203a, an inner cover 203b, and a heat insulating portion 203c. The outer cover 203a is an outer member of the cover 203 having the double structure provided on the outer side. The inner cover 203b is an inner member of the cover 203 having the double structure provided on the inner side.

The heat insulating portion 203c is formed between the outer cover 203a and the inner cover 203b. The heat insulating portion 203c exhibits a heat insulating function so as to suppress fogging on a portion of the inner cover 203b through which the laser beam used by the laser transmitter 201 passes. The heat insulating portion 203c exhibits a heat insulating function by being in a vacuum.

In the present embodiment, the entire cover 203 has the double structure. However, a portion of the cover 203 through which the laser beam used by the laser transmitter 201 passes may have a double structure.

The heater 21 is a transparent thin film member similar to the heater 11 of the first embodiment, and has carbon nanotubes and a binder. The carbon nanotubes and the binder of the heater 21 are transparent to the laser light transmitted and received by the laser transmitter 201.

The transparency of the heater 21 with respect to the laser light transmitted and received by the laser transmitter 201 is 80% or more. Therefore, it is possible to restrict the heater 21 from obstructing the passage of the laser beam through the cover 203. It is preferable that the transparency of the heater 21 with respect to the laser light transmitted and received by the laser transmitter 201 is about 95%.

The heater 21 is attached to the inner surface of the inner cover 203b by adhesive. The heater 21 may be attached to an outer surface of the inner cover 203b. The heater 21 may be insert-molded in the inner cover 203b.

The heater 21 has flexibility to fit the curved shape of the inner cover 203b. The heater 21 is provided on a part or the whole of an area of the inner cover 203b through which the laser light transmitted and received by the laser transmitter 201 passes.

The cover 203 and the heater 21 are transparent to the laser light transmitted and received by the laser transmitter 201. In other words, the cover 203 and the heater 21 transmit the laser light transmitted and received by the laser transmitter 201.

When a DC voltage is applied to an electrode (not shown) of the heater 21 from a battery (not shown) of the vehicle, a current flows through the carbon nanotube (not shown) of the heater 21 to generate heat. The electrode of the heater 21 is formed in an elongated shape along the side of the heater 21.

Since the housing 202 and the cover 203 form a closed space, fogging may occur on the inner side of the cover 203 due to a temperature difference between the inside and the outside of the closed space.

In the present embodiment, the heat insulating portion 203c exhibits a heat insulating function between the inner cover 203b and the outer cover 203a so as to suppress fogging on a portion of the inner cover 203b through which electromagnetic waves pass. According to this, it is possible to restrict fogging with a simple configuration without consuming power such as electric power.

In the present embodiment, the heat insulating portion 203c exhibits a heat insulating function by being evacuated. Thereby, high heat insulation can be exhibited.

In the present embodiment, the heater 21 is provided for heating the inner cover 203b. Thereby, the heat radiation to the outside air can be suppressed, and the efficiency of the anti-fogging by the heater 21 can be increased.

### Other Embodiments

The above-described embodiments can be appropriately combined with each other. The above-described embodiments can be variously modified as follows, for example.

(1) In the above embodiment, the heat insulating portion 3, 203c exhibits a heat insulating function by being evacuated, but the heat insulating portion 3, 203c may exhibit a heat insulating function by being filled with air.

(2) In the first embodiment, the heat insulating portion 3 exhibits a heat insulating function by being evacuated. However, the heat insulating portion 3 may be a liquid having a high heat insulating property and the same refractive index as the inner glass 2 or the windshield 1. This liquid is an organic liquid such as vegetable oil or paraffin oil.

When the heat insulating portion 3 is filled with a substance having the same refractive index as the inner glass 2 or the windshield 1, the influence caused by the difference in the refractive index with the inner glass 2 or the windshield 1 can be reduced.

(3) In the second embodiment, the heat insulating portion 203c exhibits a heat insulating function by being evacuated. Alternatively, the heat insulating portion 3 may be a liquid having a high heat insulating property and the same refractive index as the outer cover 203a or the inner cover 203b. This liquid is an organic liquid such as vegetable oil or paraffin oil.

When the heat insulating portion 203c is filled with a substance having the same refractive index as the inner cover 203b or the outer cover 203a, the influence caused by the difference in the refractive index with the inner cover 203b or the outer cover 203a can be reduced.

(4) The heat insulating portion 3, 203c may be filled with a transparent aerogel. The aerogel is, for example, a silica aerogel.

When the heat insulating portion 3, 203c is filled with aerogel, the strength of the heat insulating portion 3, 203c can be increased without lowering the transparency and the heat insulating property as much as possible.

(5) In the first embodiment, the windshield 1 and the inner glass 2 form a double window. Furthermore, one or more glasses are sandwiched between the windshield 1 and the inner glass 2 to provide a triple or more window structure.

Similarly, in the second embodiment, the outer cover 203a and the inner cover 203b form a double structure. However, one or more covers may be sandwiched between the outer cover 203a and the inner cover 203b to provide a triple or more window structure.

(6) In the first embodiment, the heater 11 is disposed on the windshield 1 within the area slightly larger than the view area v1 of the camera 100, but the heater 11 may be disposed on the entire windshield 1. Thereby, fogging of the windshield 1 can be favorably restricted. Since the heater 11 is transparent, it is possible to suppress the heater 11 from obstructing the occupant's view.

(7) In the first embodiment, the camera unit 10 and the heater 11 are arranged on the windshield 1, but the camera unit 10 and the heater 11 may be arranged on a window other than the windshield 1, such as a rear glass.

(8) In the first embodiment, the carbon nanotube 111 is used as the heating element of the heater 11. However, the heating element of the heater 11 may include a member that cannot be visually identified such as metal particles, carbon particles, and metal oxide particles. That is, the heating element of the heater 11 may include various members that are transparent to light captured by the camera 100.

(9) In the first embodiment, the image data of the camera 100 is used to restrict the collision of the vehicle, but is not limited to this. The image data of the camera 100 may be used in various applications such as lane departure restriction and inter-vehicle distance measurement.

(10) The camera 100 according to the first embodiment is a camera that captures visible light, but may be a camera that captures infrared light or ultraviolet light.

(11) The laser device 20 of the second embodiment transmits and receives laser light toward the front of the vehicle, but may transmit and receive laser light to directions other than the front of the vehicle.

For example, laser light may be transmitted and received while rotating the laser transmitter 201 in a horizontal plane. In that case, the heater 21 may be rotated together with the laser transmitter 201, or the heater 21 may be provided so as to surround the laser transmitter 360 by 360 degrees.

(12) In the second embodiment, the heater 21 is used in the laser device 20, but the heater 21 may be used in a radio device for a vehicle. The radio device is measures a distance, a direction, an attribute, and the like of a target object in response to a time period taken until a radio wave returns after being emitted and reflected by an object, and is used as, for example, a sensor for automatic driving of a vehicle.

In this case, the heater 21 removes the fogging on the cover of the radio device, thereby restricting the moisture due to the fogging from affecting the radio wave.

(13) In the second embodiment, the heating element of the heater 21 is a carbon nanotube, but the heating element of the heater 21 may be indium tin oxide or silver mesh. That is, the heating element of the heater 21 may be various members that are transparent to the laser beam used by the laser transmitter 20.

(14) In the above embodiment, the imaging device and the laser device are described as specific examples of the electromagnetic wave utilization system. However, the electromagnetic wave utilization system may be a stationary imaging device, a stationary laser device, or the like.

What is claimed is:

1. An electromagnetic wave utilization system comprising:
an electromagnetic wave device configured to send or/and receive an electromagnetic wave; and
a passage part through which passes the electromagnetic wave utilized by the electromagnetic wave device, wherein
the passage part includes
an inner member provided to face the electromagnetic wave device,
an outer member provided away from the electromagnetic wave device, and
a heat insulating portion disposed between the inner member and the outer member so as to suppress fogging on a portion of the inner member, where the electromagnetic wave passes, to exert a heat insulating function,
the electromagnetic wave utilization system further comprising: a heater configured to heat the inner member, and
the heater is a thin film member transparent to the electromagnetic wave, and is disposed on the inner member.

2. The electromagnetic wave utilization system according to claim 1, wherein the heat insulating portion is in a vacuum to exert a heat insulating function.

3. The electromagnetic wave utilization system according to claim 1, wherein the heat insulating portion is filled with a material having a same refractive index as the inner member or the outer member.

4. The electromagnetic wave utilization system according to claim 1, wherein the heat insulating portion is filled with aerogel.

5. The electromagnetic wave utilization system according to claim 1, wherein the inner member has a curved shape, and the heater has flexibility to fit the curved shape of the inner member.
